(19) United States
(12) Patent Application Publication
(10) Pub. No.: US 2016/0004386 A1
(43) Pub. Date: Jan. 7, 2016

(54) GESTURE RECOGNITION DEVICE AND GESTURE RECOGNITION METHOD

(71) Applicant: FUJITSU LIMITED, Kawasaki-shi (JP)

(72) Inventors: Kazuki OSAMURA, kawasaki (JP); Taichi MURASE, Kawasaki (JP); Takahiro MATSUDA, Isehara (JP)

(73) Assignee: FUJITSU LIMITED, Kawasaki (JP)

(21) Appl. No.: 14/737,695

(22) Filed: Jun. 12, 2015

(30) Foreign Application Priority Data
Jul. 4, 2014 (JP) 2014-139087

(51) Int. Cl. G06F 3/042; G06T 19/00; G06K 9/00; G06F 3/01

(52) U.S. Cl. CPC G06F 3/0425; G06F 3/017; G06T 19/006; G06K 9/00671

(57) ABSTRACT

A gesture recognition device includes a processor; and a memory which stores a plurality of instructions, which when executed by the processor, cause the processor to execute: acquiring, on a basis of an image of an irradiation region irradiated with projector light, the image being picked up by an image pickup device, first color information representative of color information of a hand region when the projector light is not irradiated on the hand region and second color information representative of color information of the hand region when the projector light is irradiated on the hand region; and extracting, from the image picked up by the image pickup device, a portion of the hand region at which the hand region does not overlap with a touch region irradiated with the projector light on a basis of the first color information and extracting a portion of the hand region.

### CROSS-REFERENCE TO RELATED APPLICATION

This application is based upon and claims the benefit of priority from the prior Japanese Patent Application No. 2014-139087 filed on Jul. 4, 2014, the entire contents of which are incorporated herein by reference.

### FIELD

The present embodiment discussed herein is related, for example, to a gesture recognition device, a gesture recognition method and a non-transitory computer-readable medium.

### BACKGROUND

A technology is available for projecting a virtual image on a realistic object using a projector to present a comment or menu which is associated with the realistic object. Also a technology is available wherein a fingertip of a user is recognized using a stereo camera to implement such an interaction as to touch a virtual image or draw a line on a virtual image.

As an example of a technology for detecting a hand region of a user, a prior art 1 (Japanese Laid-open Patent Publication No. 2011-118533) is described. The prior art 1 is a technology wherein a region of a color of a skin is extracted from an image picked up by a camera and a hand region is extracted from a characteristic of the shape of the extracted region of the color of the skin. FIG. 12 is a view illustrating the prior art 1.

As depicted in FIG. 12, the prior art 1 converts an input image 10a of the red-green-blue (RGB) display system acquired from a camera or the like into a hue saturation value (HSV) image 10b of the HSV display system. The prior art 1 compares color threshold values corresponding to a color of a skin and the HSV image 10b with each other to specify a region of the color of the skin. The prior art 1 sets the region of the color of the skin to pixels “0” and sets the region that does not indicate the color of the skin to pixels “1” to generate a binary digitized image 10c. The prior art 1 performs pattern matching between the shape of the binary digitized image 10c and a characteristic of a fingertip with each other to specify a fingertip. For example, in the example depicted on an image 10d, fingertips 1, 2, 3, 4 and 5 are extracted.

FIG. 13 is a view depicting an example of color threshold values corresponding to a color of a skin used in the prior art 1. In the prior art 1, color threshold values of an upper limit and a lower limit are set on each of the H axis, S axis and V axis. For example, the color threshold values on the H axis are Hₘᵢₙ and Hₘₐₓ. The color threshold values on the S axis are Sₘᵢₙ and Sₘₐₓ. The color threshold values on the V axis are Vₘᵢₙ and Vₘₐₓ. If the threshold values on the axes are indicated particularly, then the color threshold values, for example, on the H axis are set so as to satisfy 0<H<19 and 171<H<180. The color threshold values on the S axis are set so as to satisfy 40<S<121. The color threshold values on the V axis are set so as to satisfy 48<V<223. Those pixels of the HSV image 10b depicted in FIG. 12 which are included in the region defined by the color threshold values depicted in FIG. 13 correspond to the region of a color of a skin.

Here, according to the prior art 1, if projector light overlaps with a hand, then the color distribution of the hand region varies and is displaced from the extraction region of the color threshold values corresponding to the hand region, and consequently, the hand region cannot be extracted. Therefore, in order to allow detection of a hand region even when projector light overlaps with a hand, a prior art 2 (Japanese Laid-open Patent Publication No. 2005-242582) that expands the region defined by color threshold values is available.

For example, in the prior art 2, the color threshold values on the H axis are set to 0<H<21 and 176<H<180. Further, the color threshold values on the S axis are set to 40<S<178, and the color threshold values on the V axis to 45<V<236. In this manner, according to the prior art 2, by expanding the ranges defined by color threshold values, the region including a hand region may be extracted in accordance with a variation of the color distribution of the hand region.

### SUMMARY

In accordance with an aspect of the embodiments, a gesture recognition device includes a processor; and a memory which stores a plurality of instructions, which when executed by the processor, cause the processor to execute: acquiring, on a basis of an image of an irradiation region irradiated with projector light, the image being picked up by an image pickup device, first color information representative of color information of a hand region when the projector light is not irradiated on the hand region and second color information representative of color information of the hand region when the projector light is irradiated on the hand region; and extracting, from the image picked up by the image pickup device, a portion of the hand region at which the hand region does not overlap with a touch region irradiated with the projector light on a basis of the first color information and extracting a portion of the hand region at which the hand region overlaps with the touch region irradiated with the projector light on a basis of the second color information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a functional block diagram depicting a configuration of a gesture recognition device according to an embodiment;

FIG. 2 is a view depicting an example of image data where projector light is not irradiated;

FIG. 3 is a view illustrating a process performed by an acquisition section for specifying first color threshold values;

FIG. 4 is a view depicting an example of image data where projector light is irradiated;

FIG. 5 is a view illustrating a process performed by an acquisition section for specifying second color threshold values;

FIG. 6 is a view (1) illustrating a process for determining whether or not a touch region and a hand region overlap with each other;

FIG. 7 is a view supplementarily illustrating a process of an extraction section where a touch region and a hand region overlap with each other;

FIG. 8 is a flow chart illustrating a process for calculating first and second color threshold values;

FIG. 9 is a flow chart illustrating a process for extracting a hand region;

FIG. 10 is a view (2) illustrating a process for determining whether or not a touch region and a hand region overlap with each other;

FIG. 11 is a view depicting an example of a computer that executes a gesture recognition program;

FIG. 12 is a view illustrating a prior art 1; and

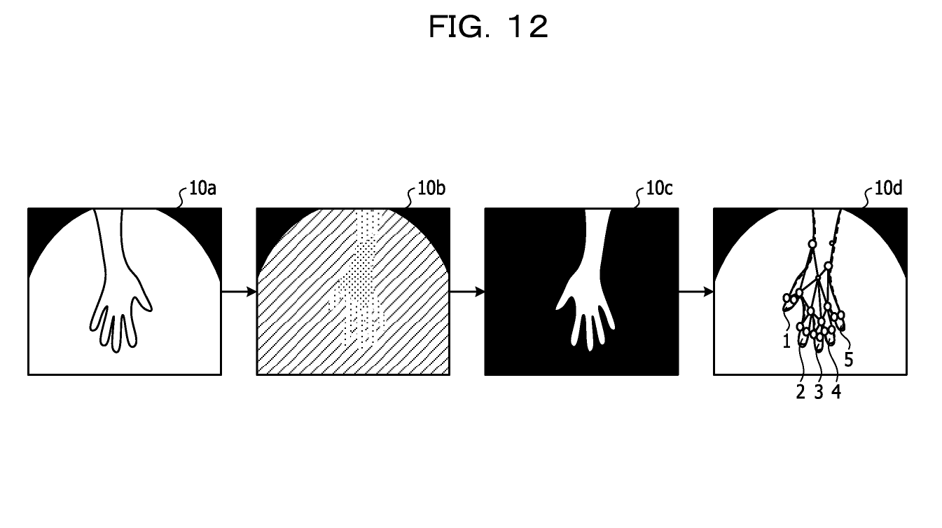

FIG. 13 is a view depicting an example of color threshold values corresponding to a color of a skin used in the prior art 1.

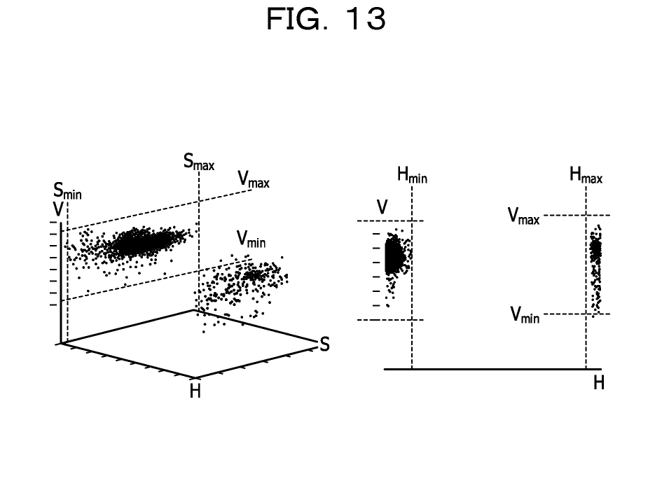

### DESCRIPTION OF EMBODIMENT

In the following, an embodiment of a gesture recognition device and a gesture recognition program disclosed herein is described with reference to the drawings. It is to be noted that the present technology is not restricted by the embodiment.

### Embodiment

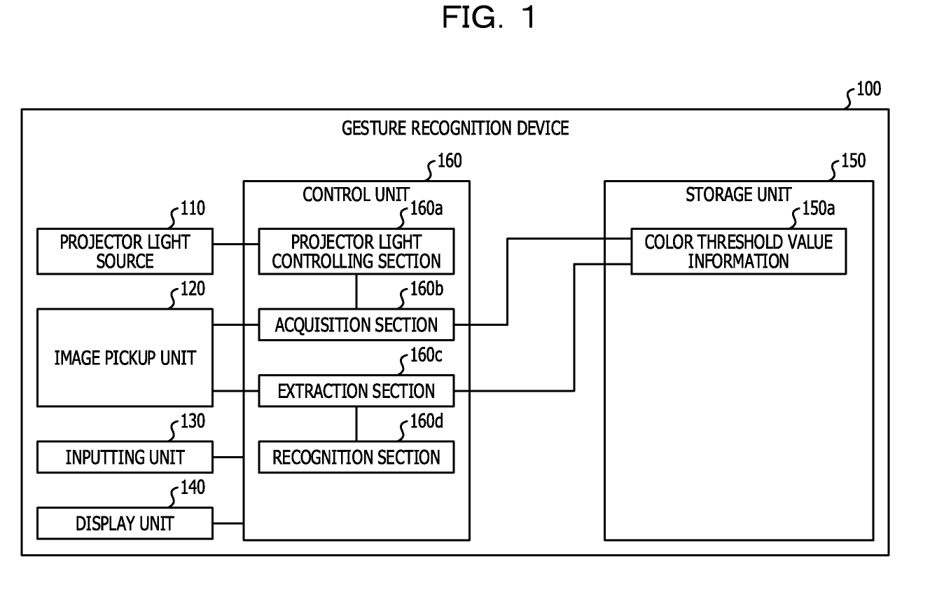

An example of the configuration of the gesture recognition device according to the present embodiment is described. FIG. 1 is a functional block diagram depicting a configuration of a gesture recognition device according to an embodiment. As depicted in FIG. 1, a gesture recognition device 100 includes a projector light source 110, an image pickup unit 120, an inputting unit 130, a display unit 140, a storage unit 150, and a control unit 160.

The projector light source 110 is a device that irradiates projector light corresponding to various colors or images on the basis of information accepted from a projector light controlling section 160a. The projector light source 110 corresponds, for example, to a light emitting diode (LED) light source.

The image pickup unit 120 is a device that picks up an image of an irradiation region upon which light is irradiated from the projector light source 110. The image pickup unit 120 outputs image data of a picked up image to an acquisition section 160b and an extraction section 160c. The image pickup unit 120 corresponds to a camera or the like.

The inputting unit 130 is an inputting device that inputs various kinds of information to the gesture recognition device 100. The inputting unit 130 corresponds, for example, to a keyboard, a mouse, a touch panel or the like.

The display unit 140 is a display device that displays information inputted thereto from the control unit 160. The display unit 140 corresponds, for example, to a liquid crystal display unit, a touch panel or the like.

The storage unit 150 includes color threshold value information 150a. The storage unit 150 corresponds to a storage device such as a semiconductor memory such as, for example, a random access memory (RAM), a read only memory (ROM), or a flash memory, a hard disk drive (HDD) or the like.

The color threshold value information 150a includes initial color threshold values, color threshold values Th1 and color threshold values Th2. The initial color threshold values are color threshold values defining rather wide ranges therebetween so that a hand region may be extracted with certainty. For example, the initial color threshold values are defined by the following expressions (1), (2) and (3):

0<H<20,170<H<180 (1)

60<S<200 (2)

45<V<255 (3)

The color threshold values Th1 are generated by the acquisition section 160b hereinafter described. The color threshold values Th1 are used for extracting a hand region and define narrow ranges in comparison with the ranges defined by the initial color threshold values described hereinabove. Generation of the color threshold values Th1 by the acquisition section 160b is hereinafter described.

The color threshold values Th2 are generated by the acquisition section 160b hereinafter described. The color threshold values Th2 are used to extract a region of a location irradiated by projector light from within a hand region. Generation of the color threshold values Th2 by the acquisition section 160b is hereinafter described.

The control unit 160 includes the projector light controlling section 160a, the acquisition section 160b, the extraction section 160c, and a recognition section 160d. The control unit 160 corresponds to an accumulation device such as, for example, an application specific integrated circuit (ASIC) or a field programmable gate array (FPGA). The control unit 160 further corresponds to an electronic circuit such as, for example, a central processing unit (CPU) or a micro processing unit (MPU).

The projector light controlling section 160a outputs information to the projector light source 110 so that the projector light source 110 irradiates projector light corresponding to various colors or images. If an irradiation request for projector light is accepted from the acquisition section 160b, then the projector light controlling section 160a has the projector light source 110 irradiate projector light upon a position designated by the acquisition section 160b. For example, the position designated by the acquisition section 160b is the position of the center of gravity of the hand region.

If the projector light controlling section 160a accepts an irradiation stopping request of projector light from the acquisition section 160b, the projector light controlling section 160a controls the projector light source 110 to stop irradiation of projector light.

The acquisition section 160b is a processing unit that specifies, on the basis of image data acquired from the image pickup unit 120, the color threshold values Th1 for a hand region when no projector light is irradiated upon the hand region. Further, the acquisition section 160b is a processing unit that specifies, while projector light is irradiated upon the hand region, the color threshold values Th2 when projector light is irradiated upon the hand region on the basis of image data acquired from the image pickup unit 120. It is assumed that, while the acquisition section 160b specifies the color threshold values Th1 and the color threshold values Th2, the user places a hand within the irradiation region of projector light and does not move the hand.

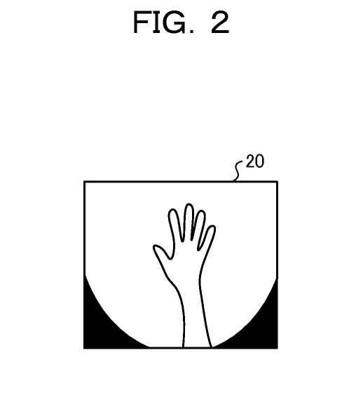

An example of a process of the acquisition section 160b when the acquisition section 160b specifies the color threshold values Th1 is described. The acquisition section 160b acquires image data in a state in which no light of an image or various colors is irradiated by the projector light source 110 from the image pickup unit 120. FIG. 2 is a view depicting an example of image data where projector light is not irradiated. Image data 20 depicted in FIG. 2 is image data of the RGB display system and image data picked up with nothing in the background other than a hand and fingers. In order to acquire the image data 20, the acquisition section 160b outputs an irradiation stopping request to the projector light controlling section 160a.

The acquisition section 160b converts the image data 20 of the RGB display system into an HSV image of the HSV display system. The acquisition section 160b compares initial color threshold values included in the color threshold value information 150a with values of pixels of the HSV image to specify the pixels that are included within the range defined by the initial color threshold values. The acquisition section 160b sets the region of the specified pixels as a hand region.

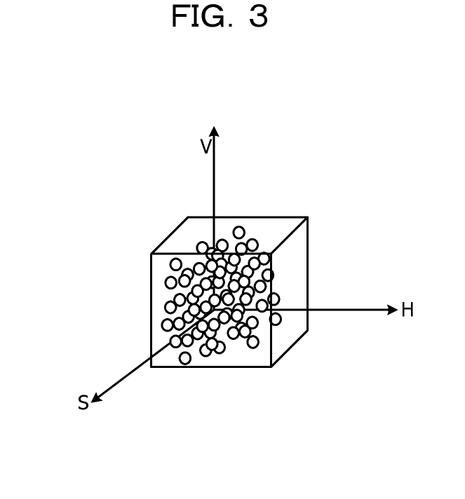

The acquisition section 160b specifies the color threshold values Th1 on the basis of the range of the HSV display system of the pixels included in the hand region. FIG. 3 is a view illustrating a process performed by the acquisition section 160b for specifying the color threshold values Th1. In FIG. 3, the H axis corresponds to the Hue of the HSV display system; the S axis corresponds to the Saturation; and the V axis corresponds to the Value.

The acquisition section 160b sets the maximum value of H from among the values of H corresponding to all pixels included in the hand region in FIG. 3 to Hₘₐₓ of the color threshold values Th1. The acquisition section 160b sets the minimum value of H from among the values of H corresponding to all pixels included in the hand region to Hₘᵢₙ of the color threshold values Th1.

The acquisition section 160b sets the maximum value of S from among the values of S corresponding to all pixels included in the hand region in FIG. 3 to Sₘₐₓ of the color threshold values Th1. The acquisition section 160b sets the minimum value of S from among the values of S corresponding to all pixels included in the hand region to Sₘᵢₙ of the color threshold values Th1.

The acquisition section 160b sets the maximum value of V from among the values of V corresponding to all pixels included in the hand region in FIG. 3 to Vₘₐₓ of the color threshold values Th1. The acquisition section 160b sets the minimum value of V from among the values of V corresponding to all pixels included in the hand region to Vₘᵢₙ of the color threshold values Th1.

The acquisition section 160b specifies the color threshold values Th1 by specifying the maximum value and the minimum value on each of the axes as described above. The acquisition section 160b updates the color threshold value information 150a with the specified information of the color threshold values Th1.

Now, an example of a process performed by the acquisition section 160b when the acquisition section 160b specifies the color threshold values Th2 is described. The acquisition section 160b specifies a hand region in a similar manner as in the process for specifying the color threshold values Th1 described above. The acquisition section 160b calculates the position of the center of gravity of the hand region. The acquisition section 160b outputs the position of the center of gravity of the hand region to the projector light controlling section 160a and issues an irradiation request.

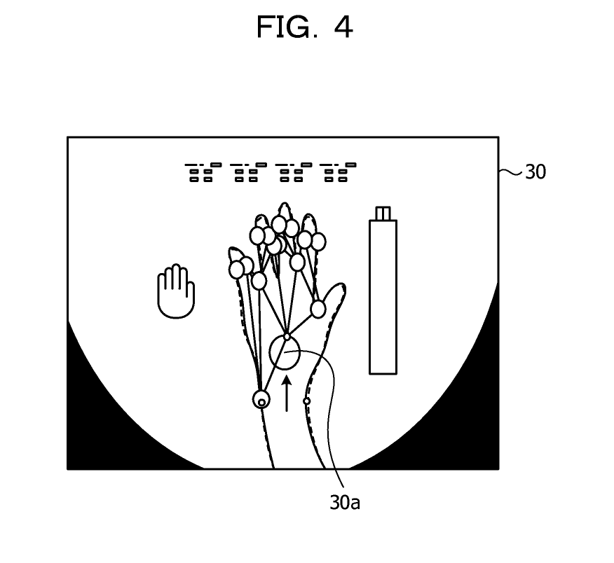

After issuing the irradiation request, the acquisition section 160b acquires image data in a state in which projector light is irradiated from the image pickup unit 120. FIG. 4 is a view depicting an example of image data where projector light is irradiated. In the example depicted in FIG. 4, projector light is irradiated at the position 30a of the center of gravity of image data 30. The image data 30 is image data of the RGB display system.

The acquisition section 160b converts the image data 30 of the RGB display system into an HSV image of the HSV display system. The acquisition section 160b specifies an image within a given range from the position of the center of gravity of the HSV image after the conversion. The position of the center of gravity corresponds to the position of the center of gravity of the hand region described above.

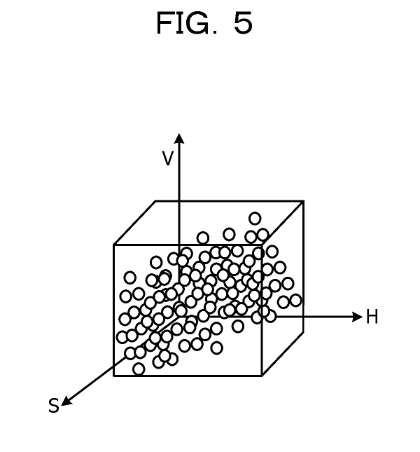

The acquisition section 160b specifies the color threshold values Th2 on the basis of the range of the HSV display system of the pixels included in the given range from the position of the center of gravity. FIG. 5 is a view illustrating a process performed by the acquisition section 160b for specifying the color threshold values Th2. The axes in FIG. 5 are similar to the axes in FIG. 3.

The acquisition section 160b sets the maximum value of H from among values of H of all pixels included in the given range from the position of the center of gravity in FIG. 5 to Hₘₐₓ of the color threshold values Th2. The acquisition section 160b sets the minimum value of H from among the values of H of all pixels included in the given range from the position of center of gravity to Hₘᵢₙ of the color threshold values Th2.

The acquisition section 160b sets the maximum value of S from among values of S of all pixels included in the given range from the position of the center of gravity in FIG. 5 to Sₘₐₓ of the color threshold values Th2. The acquisition section 160b sets the minimum value of S from among the values of S of all pixels included in the given range from the position of center of gravity to Sₘᵢₙ of the color threshold values Th2.

The acquisition section 160b sets the maximum value of V from among values of V of all pixels included in the given range from the position of the center of gravity in FIG. 5 to Vₘₐₓ of the color threshold values Th2. The acquisition section 160b sets the minimum value of V from among the values of V of all pixels included in the given range from the position of center of gravity to Vₘᵢₙ of the color threshold values Th2.

The acquisition section 160b specifies the color threshold values Th2 by specifying the maximum value and the minimum value on each of the axes as described above. The acquisition section 160b updates the color threshold value information 150a with the specified information of the color threshold values Th2.

The extraction section 160c extracts a portion of the hand region at which the hand region does not overlap with a touch region irradiated with projector light on the basis of the color threshold values Th1. Further, the extraction section 160c extracts a portion of the hand region at which the hand region overlaps with the touch region irradiated with projector light on the basis of the color threshold values Th2. The extraction section 160c couples the portion of the hand region extracted on the basis of the color threshold values Th1 and the portion of the hand region extracted on the basis of the color threshold values Th2 as a hand region. The extraction section 160c outputs the information of the hand region to the recognition section 160d.

First, an example of a process performed by the extraction section 160c for determining whether or not a touch region irradiated with projector light and a hand region overlap with each other is described. The extraction section 160c acquires image data of the RGB display system from the image pickup unit 120 and specifies a fingertip of a hand region similarly as in the process performed by the acquisition section 160b described hereinabove.

For example, the extraction section 160c converts the image data of the RGB display system into image data of the HSV display system. The extraction section 160c compares the color threshold values Th1 included in the color threshold value information 150a with values of pixels of the HSV image to specify the pixels that are included in the range represented by the color threshold values Th1. The extraction section 160c sets the region of the specified pixels as a hand region.

The extraction section 160c performs pattern matching between the hand region and characteristics of the fingertip to specify the fingertip and calculates coordinates of the specified fingertip on the image data. The extraction section 160c determines that the touch region and the hand region overlap with each other when the distance between the coordinates of the fingertip and the coordinates of the touch region is smaller than a threshold value. On the other hand, when the distance between the coordinates of the fingertip and the coordinates of the touch region is equal to or greater than the threshold value, the extraction section 160c determines that the touch region and the hand region do not overlap with each other. It is to be noted that it is assumed that the extraction section 160c retains the coordinates of the touch region on the image data in advance.

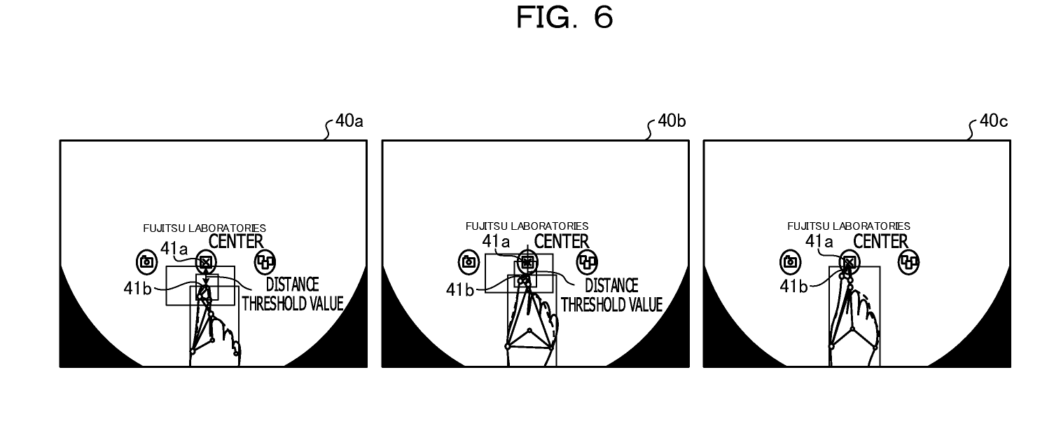

FIG. 6 is a view (1) illustrating a process for determining whether or not a touch region and a hand region overlap with each other. In an image 40a depicted in FIG. 6, the distance between the coordinates 41a of the touch region and the coordinates 41b of the fingertip is equal to or greater than the threshold value. Therefore, in the case of the image 40a, the extraction section 160c determines that the touch region and the hand region do not overlap with each other.

In images 40b and 40c depicted in FIG. 6, the distance between the coordinates 41a of the touch region and the coordinates 41b of the fingertip is smaller than the threshold value. Therefore, in the cases of the images 40b and 40c, the extraction section 160c determines that the touch region and the hand region overlap with each other.

Now, a process performed by the extraction section 160c for extracting a hand region when the hand region and the touch region do not overlap with each other is described. The extraction section 160c acquires image data of the RGB display system from the image pickup unit 120 and converts the image data of the RGB display system into an image of the HSV display system. The extraction section 160c compares the color threshold values Th1 included in the color threshold value information 150a and values of the pixels of the HSV display system with each other to specify the pixels that are included in the range defined by the color threshold values Th1. The extraction section 160c specifies the region of the specified pixels as a hand region. The extraction section 160c outputs the information of the specified hand region to the recognition section 160d.

Now, a process performed by the extraction section 160c for extracting a hand region when the hand region and the touch region overlap with each other is described. When the hand region and the touch region overlap with each other, the extraction section 160c couples a portion of the hand region extracted on the basis of the color threshold values Th1 and a portion of the hand region extracted on the basis of the color threshold values Th2 to each other and specifies the coupled region as a hand region.

First, the extraction section 160c acquires image data of the RGB display system from the image pickup unit 120 and converts the image data of the RGB display system into an image of the HSV display system. The extraction section 160c compares the color threshold values Th1 included in the color threshold value information 150a with the values of pixels of the HSV image to specify the pixels included in the range defined by the color threshold values Th1. The extraction section 160c specifies a region of the specified pixels as a portion of the hand region.

The extraction section 160c compares the color threshold values Th2 included in the color threshold value information 150a with values of pixels of the HSV image to specify the pixels included in the range defined by the color threshold values Th2. The extraction section 160c specifies the region of the specified pixels as a portion of the hand region.

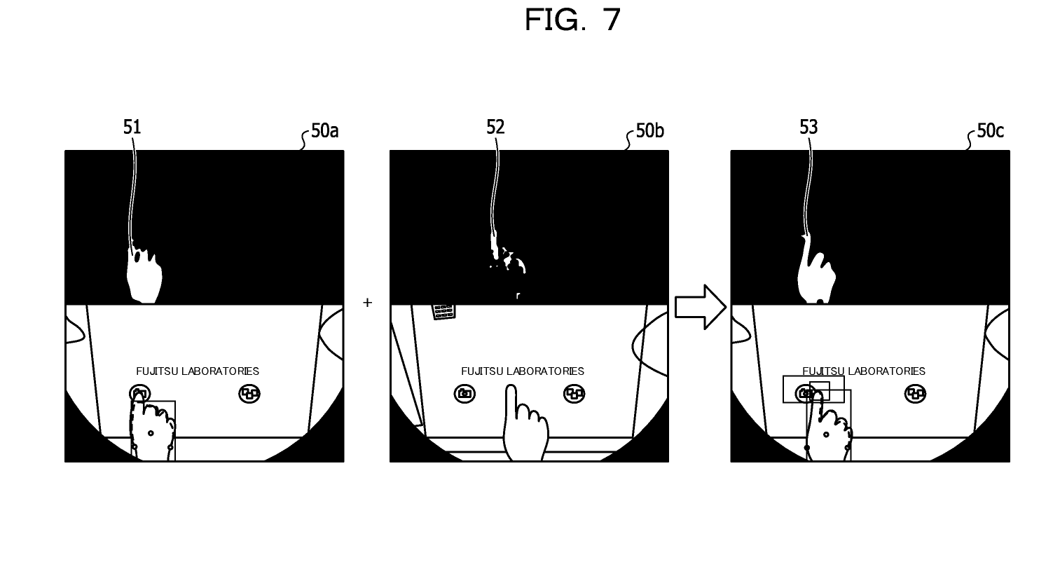

FIG. 7 is a view supplementarily illustrating a process of the extraction section 160c where a touch region and a hand region overlap with each other. A hand region 51 depicted on an image 50a depicted in FIG. 7 represents a portion of the hand region extracted on the basis of the color threshold values Th1. Another hand region 52 depicted on an image 50b depicted in FIG. 7 represents a portion of the hand region extracted on the basis of the color threshold values Th2. A hand region 53 depicted on an image 50c is a region generated by the extraction section 160c coupling the hand region 51 and the hand region 52 to each other. The extraction section 160c outputs the information of the coupled hand region 53 to the recognition section 160d.

The recognition section 160d is a processing unit that recognizes various gestures on the basis of the information of the hand region accepted from the extraction section 160c and performs various processes in response to a result of the recognition. For example, the recognition section 160d successively acquires information of a hand region from the extraction section 160c, compares a locus of a fingertip of the hand region and a given pattern with each other and performs a process in response to a pattern corresponding to the locus. The recognition section 160d may determine whether or not the touch region and the hand region overlap with each other in a similar manner as the determination performed by the extraction section 160c, determine whether or not the touch region is touched by the user and performs a process in response to the touch region touched by the user.

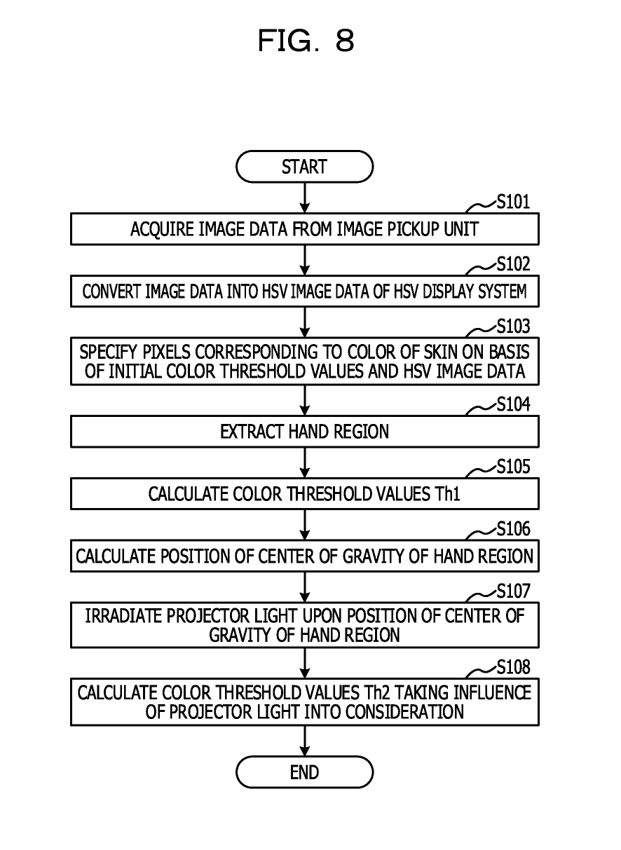

Now, a process of the gesture recognition device 100 according to the present embodiment is described. FIG. 8 is a flow chart illustrating a process for calculating the color threshold values Th1 and Th2. As depicted in FIG. 8, the acquisition section 160b of the gesture recognition device 100 acquires image data from the image pickup unit 120 (step S101).

The acquisition section 160b converts the image data into HSV image data of the HSV display system (step S102). The acquisition section 160b compares the initial color threshold values and the HSV image data with each other to specify pixels corresponding to a color of a skin (step S103) and then extracts a hand region (step S104).

The acquisition section 160b calculates the color threshold values Th1 on the basis of the HSV values of the pixels included in the hand region (step S105). The acquisition section 160b calculates the position of the center of gravity of the hand region (step S106).

The projector light controlling section 160a of the gesture recognition device 100 controls the projector light source 110 to irradiate projector light on the position of the center of gravity of the hand region (step S107). The acquisition section 160b calculates the color threshold values Th2 taking an influence of the projector light into consideration (step S108).

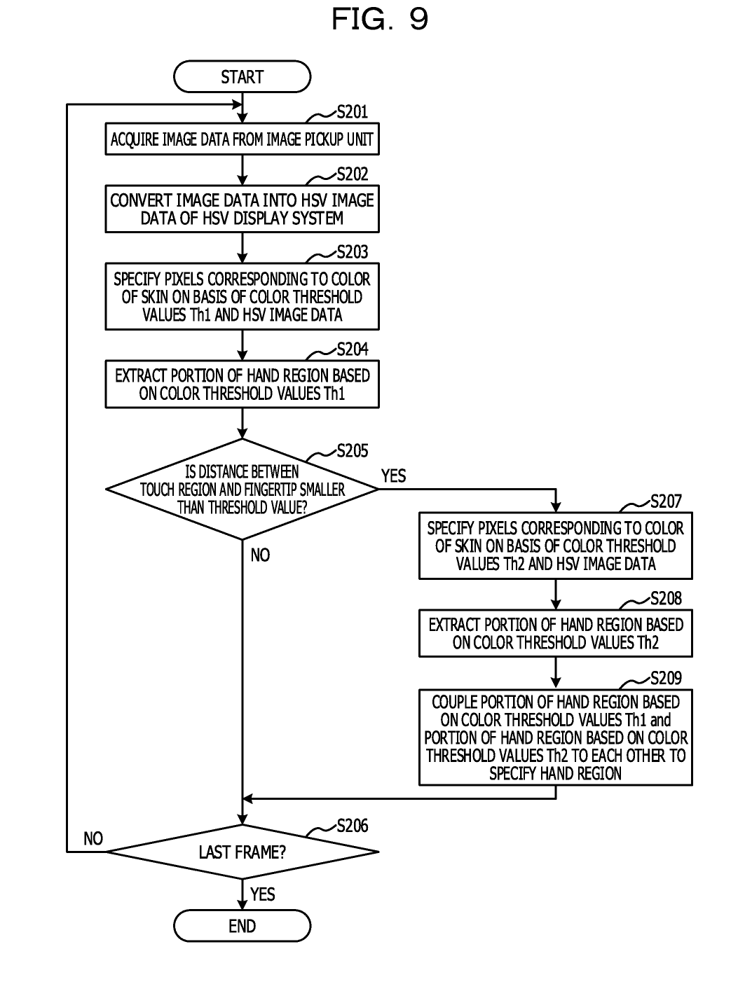

FIG. 9 is a flow chart illustrating a process for extracting a hand region. As depicted in FIG. 9, the extraction section 160c of the gesture recognition device 100 acquires image data from the image pickup unit 120 (step S201).

The extraction section 160c converts the image data into HSV image data of the HSV display system (step S202). The extraction section 160c specifies pixels corresponding to a color of a skin on the basis of the color threshold values Th1 and the HSV image data (step S203) and extracts a portion of the hand region based on the color threshold values Th1 (step S204).

The extraction section 160c determines whether or not the distance between the touch region and the fingertip is smaller than the threshold value (step S205). If the distance between the touch region and the fingertip is not smaller than the threshold value (No in step S205), then the extraction section 160c determines whether or not the frame in question is the last frame (step S206).

If the frame in question is the last frame (Yes in step S206), then the extraction section 160c ends its process. On the other hand, if the frame in question is not the last frame (No in step S206), then the extraction section 160c returns its process to step S201.

Returning to the description at step S205, if the distance between the touch region and the fingertip is smaller than the threshold value (Yes in step S205), then the extraction section 160c specifies the pixels corresponding to a color of the skin on the basis of the color threshold values Th2 and the HSV image data (step S207) and extracts a portion of the hand region based on the color threshold values Th2 (step S208).

The extraction section 160c couples the portion of the hand region based on the color threshold values Th1 and the portion of the hand region based on the color threshold values Th2 to specify the hand region (step S209), whereafter the extraction section 160c advances the process to step S206.

Now, effects of the gesture recognition device 100 according to the present embodiment are described. The gesture recognition device 100 determines whether or not a touch region irradiated by the projector light source 110 and a fingertip of a user overlap with each other. If the touch region and the fingertip of the user overlap with each other, then the gesture recognition device 100 uses the color threshold values Th1 and the color threshold values Th2 to specify the hand region. Therefore, with the gesture recognition device 100, even when projector light is irradiated upon the hand region, the hand region may be extracted accurately.

Further, the gesture recognition device 100 determines whether or not projector light and a hand region overlap with each other on the basis of the distance between the position of the touch region irradiated with projector light and the position of the hand region. Therefore, the gesture recognition device 100 may accurately determine whether or not projector light and the hand region overlap with each other. Consequently, erroneous detection of the hand region may be minimized.

Further, the gesture recognition device 100 couples a portion of the hand region extracted on the basis of the color threshold values Th1 and a portion of the hand region extracted on the basis of the color threshold values Th2 to each other to determine the hand region. Therefore, the hand region that does not overlap with projector light and the hand region that overlaps with the projector light may be extracted. Consequently, extraction of a background image may be minimized.

Incidentally, although the extraction section 160c described above determines whether or not a touch region and a hand region overlap with each other on the basis of the distance between the touch region and the fingertip, the determination is not limited to this. For example, the extraction section 160c may acquire image data in a touch region from the image pickup unit 120 and determine whether or not the touch region and a hand region overlap with each other on the basis of the difference of the image data.

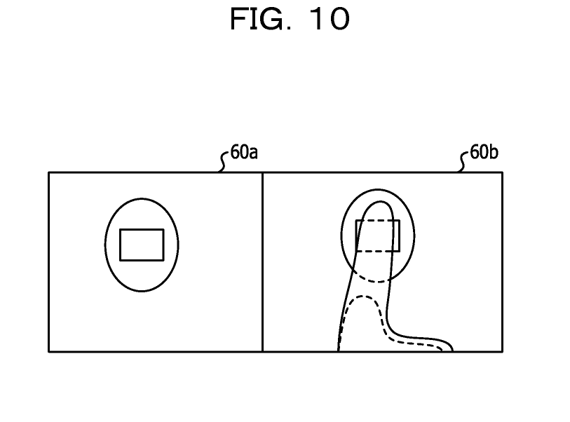

FIG. 10 is a view (2) illustrating a process for determining whether or not a touch region and a hand region overlap with each other. Image data 60a is background image data retained in advance by the extraction section 160c. Image data 60b is image data acquired from the image pickup unit 120 by the extraction section 160c.

The extraction section 160c generates difference image data by calculating the difference between pixel values of pixels of the image data 60a and pixel values of pixels of the image data 60b. When the number of the pixels whose pixel value is different from 0 in the difference image data is equal to or greater than a given threshold value, the extraction section 160c determines that the touch region and the hand region overlap with each other. It is to be noted that, while an overlap between the touch region and the hand region here is detected from the difference between the image data 60a and the image data 60b on the basis of the number of the pixels, the extraction section 160c may detect an overlap through some other processes.

Since the extraction section 160c determines whether or not a touch region and a hand region overlap with each other on the basis of the difference of the image data in the touch region as described above, it may be determined by the simple and easy technique whether or not the touch region is touched by a fingertip of a user.

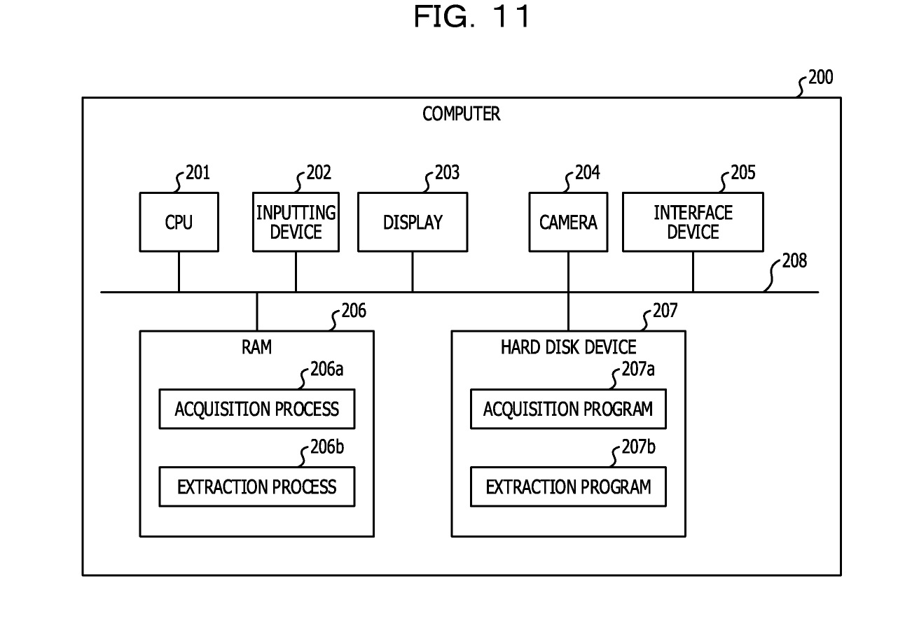

Now, an example of a computer that executes an electronic watermark information detection program for implementing a function similar to the function of the gesture recognition device 100 described in connection with the embodiment described above is described. FIG. 11 is a view depicting an example of a computer that executes a gesture recognition program.

As depicted in FIG. 11, a computer 200 includes a CPU 201 that executes various arithmetic operations, an inputting device 202 that accepts an input of data from a user, and a display unit 203. The computer 200 further includes a camera 204 for picking up an image, and an interface device 205 that performs transmission and reception of data to and from a different computer through a network. The computer 200 further includes a RAM 206 that temporarily stores various kinds of information, and a hard disk device 207. The components of the computer 200 mentioned are coupled to a bus 208.

The hard disk device 207 includes an acquisition program 207a and an extraction program 207b. The CPU 201 reads out the acquisition program 207a and the extraction program 207b and deploys the acquisition program 207a and the extraction program 207b in the RAM 206. The acquisition program 207a functions as an acquisition process 206a. The extraction program 207b functions as an extraction process 206b.

The acquisition process 206a corresponds to the acquisition section 160b. The extraction process 206b corresponds to the extraction section 160c.

It is to be noted that the acquisition program 207a and the extraction program 207b may not necessarily be stored in the hard disk device 207 from the beginning. For example, the acquisition program 207a and the extraction program 207b are stored, for example, into a “portable physical medium” such as a flexible disk (FD), a compact disc read only memory (CD-ROM), a digital versatile disc (DVD), a magneto-optical disk or an integrated circuit (IC) card, which are inserted into the computer 200. Then, the computer 200 may read out and execute the acquisition program 207a and the extraction program 207b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A gesture recognition device, comprising:
a processor; and
a memory which stores a plurality of instructions, which when executed by the processor, cause the processor to execute:
acquiring, on a basis of an image of an irradiation region irradiated with projector light, the image being picked up by an image pickup device, first color information representative of color information of a hand region when the projector light is not irradiated on the hand region and second color information representative of color information of the hand region when the projector light is irradiated on the hand region; and
extracting, from the image picked up by the image pickup device,
a portion of the hand region at which the hand region does not overlap with a touch region irradiated with the projector light on a basis of the first color information and extracting a portion of the hand region at which the hand region overlaps with the touch region irradiated with the projector light on a basis of the second color information.

2. The device according to claim 1,
wherein the extracting acquires an image of the touch region irradiated with the projector light and determines on a basis of a difference of the image whether or not the projector light and the hand region overlap with each other.

3. The device according to claim 1,
wherein the extracting determines whether or not the projector light and the hand region overlap with each other on a basis of a distance between a position of the touch region at which the touch region is irradiated with the projector light and a position of the hand region.

4. The device according to claim 1,
wherein the extracting couples the portion of the hand region extracted on a basis of the first color information and the portion of the hand region extracted on a basis of the second color information to each other to determine the hand region.

5. A gesture recognition method, comprising:
acquiring, on a basis of an image of an irradiation region irradiated with projector light, the image being picked up by an image pickup device, first color information representative of color information of a hand region when the projector light is not irradiated on the hand region and second color information representative of color information of the hand region when the projector light is irradiated on the hand region; and
extracting, by a computer processor, from the image picked up by the image pickup device, a portion of the hand region at which the hand region does not overlap with a touch region irradiated with the projector light on a basis of the first color information and extracting a portion of the hand region at which the hand region overlaps with the touch region irradiated with the projector light on a basis of the second color information.

6. The method according to claim 5,
wherein the extracting acquires an image of the touch region irradiated with the projector light and determines on a basis of a difference of the image whether or not the projector light and the hand region overlap with each other.

7. The method according to claim 5,
wherein the extracting determines whether or not the projector light and the hand region overlap with each other on a basis of a distance between a position of the touch region at which the touch region is irradiated with the projector light and a position of the hand region.

8. The method according to claim 5,
wherein the extracting couples the portion of the hand region extracted on a basis of the first color information and the portion of the hand region extracted on a basis of the second color information to each other to determine the hand region.

9. A non-transitory computer-readable medium that stores a gesture recognition program for causing a computer to execute a process comprising:
acquiring, on a basis of an image of an irradiation region irradiated with projector light, the image being picked up by an image pickup device, first color information representative of color information of a hand region when the projector light is not irradiated on the hand region and second color information representative of color information of the hand region when the projector light is irradiated on the hand region; and
extracting, from the image picked up by the image pickup device, a portion of the hand region at which the hand region does not overlap with a touch region irradiated with the projector light on a basis of the first color information and extracting a portion of the hand region at which the hand region overlaps with the touch region irradiated with the projector light on a basis of the second color information.
